(19) United States
(12) Patent Application Publication
(10) Pub. No.: US 2009/0247254 A1
(43) Pub. Date: Oct. 1, 2009

(54) PHYSICS MODELING FOR GAMING MACHINE DISPLAYS

(75) Inventors: Greg A. Schlottmann, Sparks, NV (US); Jamal Benbrahim, Reno, NV (US); Steven G. LeMAY, Reno, NV (US); Michael M. Oberberger, Reno, NV (US)

Correspondence Address: Weaver Austin Villeneuve & Sampson LLP - IGT;Attn: IGT, P.O. Box 70250, Oakland, CA, 94612-0250, US

(73) Assignee: IGT, Reno, NV (US)

(21) Appl. No.: 12/055,231

(22) Filed: Mar. 25, 2008

(51) Int. Cl. A63F 13/00

(52) U.S. Cl. 463/16

(57) ABSTRACT

A gaming machine may have at least one wager input mechanism for receiving a wager, a player input mechanism to detect an input signal from the player, a master gaming controller configured to present a game of chance, receive a wager input signal indicating the amount of a wager, receive the player input signal, and generate a predetermined game outcome for the game of chance, and a physics processor coupled to the master gaming controller and configured to generate physics data. The physics data is generated based upon the predetermined game outcome and the player input signal. The gaming machine may also have a display coupled to the master gaming controller to display a realistic animation of the play of the game of chance, wherein the realistic animation of the game play is based on the physics data.

### TECHNICAL FIELD

The present invention generally relates to computerized graphical displays, and more particularly to the generation of multi-object animated graphics for the displays of wager based gaming machines.

### BACKGROUND

Casinos and other forms of gaming comprise a growing multi-billion dollar industry wherein electronic and microprocessor based gaming machines have become increasingly popular in recent years. In a typical electronic gaming machine, such as a slot machine, video poker machine, video keno machine or the like, a game play is first initiated through a player wager of money or credit, whereupon the gaming machine determines a game outcome, presents the game outcome to the player and then potentially dispenses an award of some type, including a monetary award, depending upon the game outcome. This determination of a game outcome and potential award to a player are typically controlled by a master gaming controller (MGC) within the gaming machine, which MGC can be responsible for numerous other gaming machine processing functions also. Many additional gaming machine components, features and programs have been made possible in recent years through this proliferation of electronic gaming machines, including those involving linked progressive jackpots, player tracking and loyalty points programs, among other items.

Currently, electronic and microprocessor based gaming machines memories typically store numerous sets of predetermined display conditions with predetermined outcomes for each game of chance played. The modeling of the game play is processor intensive and predetermined. The display of the actual game play is typically limited to pre-scripted animations triggered by in-game events, with such animations including, for example, the “stopping” of a virtual slot machine reel, or the resulting “trajectory” of a pachinko ball when the ball hits a certain pin at a certain location. Because gaming machine processing tends to determine a game outcome before displaying these relatively simple pre-scripted animations, players are sometimes not given a full sense of realism with respect to the simulated physical environment displayed by the game play on a wager based gaming machine.

Gaming machine players have shown a great appetite for sophisticated entertainment that accurately simulates reality. A high degree of computer-animated realism requires lifelike interaction between game objects. For example, many people intuitively understand that a real pachinko ball reacts differently when bouncing off a metal pin, another pachinko ball, or a piece of plastic, as compared to truly elastic surfaces. A lifelike graphical simulation of a pachinko ball bouncing across these disparate surfaces within a pachinko game environment should thus account for the different physical properties (e.g., friction, rigidity) of these respective surfaces and their influence on the motion of the ball. Within a typical gaming machine environment, however, traditional processors running typically available software tend to be able to simulate and visually display only relatively simple physics-based interactions, such as an animation of a pachinko ball bouncing off a pin in an elastic manner. As such, a sense of realism can be missing from many gaming machine graphical simulations.

Some processor based gaming machines can include graphical content intended to run with the aid of Graphics Processing Units (GPUs) such as a graphics or video card. GPUs are well know in the industry and are specifically designed to run in cooperation with a master gaming controller to create, for example, animations having a three dimensional (3-D) quality. Although capable of generating ample graphics to display a game of chance, GPUs are not built for physics processing, nor are they engineered to drive highly specialized physics calculations. Accordingly, the simulation of complex multi-object animations, such as, for example, the simultaneous play of numerous pachinko balls in a virtual pachinko game, can be difficult, with the resulting display appearing choppy or unrealistic to some players.

While existing systems and methods for providing simulated gaming environments on processor based gaming machines have been adequate in the past, improvements are usually welcomed and encouraged. In light of the foregoing, it is desirable to develop systems and methods that permit a more realistic animated display of multiple objects in a virtual gaming machine environment.

### SUMMARY

It is an advantage of the present invention to provide systems and methods that permit improved physics modeling on a gaming machine display with respect to multiple object animations. This can be accomplished at least in part through the use of a specialized physics processor in the systems and methods provided herein. The use of such a physics processor utilizes less memory space, provides for an improved animated display of a game outcome in real time, and allows for improved player perception of the game play and outcome.

In various embodiments, a gaming machine may have at least one wager input mechanism for receiving a wager by a player to play a game of chance, a player input mechanism to detect a real-time input signal from a player to play the game of chance, a master gaming controller, a physics processor coupled to the master gaming controller and designed or configured to generate physics data, and a display coupled to the master gaming controller to display a realistic animation of the game outcome. The physics data can be generated based upon the game outcome and the real-time player input signal received from the master gaming controller. The realistic animation of the game outcome can be modeled from the physics data generated in real-time. The master gaming controller can be configured to receive the wager input signal indicating the amount of the wager received, receive the real-time player input signal, determine a game outcome for the game of chance, and present the game of chance to the player.

In various embodiments, the specialized physics processing can be done by a separate dedicated processor that is specifically adapted for use in calculating physics data and modeling outputs therefrom. Such a separate dedicated processor can be located separately from the CPU, MGC and/or video cards in the gaming machine. In some embodiments, the physics processing can be done on the video card itself, such as where one or more processors especially adapted to perform physics calculations and modeling are on the video card. In embodiments involving multi-core systems, one or more of the cores can be dedicated to doing the physics processing, while the other core or cores can perform all other core functions.

In various embodiments, methods for playing a game of chance are provided. Such methods may include the steps of receiving a wager of an indicia of credit on an outcome of the game of chance, determining under control of a master gaming controller a game outcome for the game of chance, receiving a player input signal to play the game of chance, calculating physics data by a physics processor based upon the game outcome for the game of chance and the player input signal, and displaying a realistic animation of the game of chance on a display, wherein the realistic animation is modeled upon the physics data calculated in real-time. In such methods, the gaming machine can include a wager input mechanism for allowing the indicia of credit to be added to the gaming machine and a wager output mechanism for allowing a player

Other apparatuses, systems, methods, features and advantages of the invention will be or will become apparent to one with skill in the art upon examination of the following figures and detailed description. It is intended that all such additional methods, features and advantages be included within this description, be within the scope of the invention, and be protected by the accompanying claims.

### BRIEF DESCRIPTION OF THE DRAWINGS

The accompanying drawings, which are incorporated into and constitute a part of this specification, illustrate one or more embodiments and, together with the detailed description, serve to explain the principles and implementations of the invention. These drawings are for illustrative purposes and serve only to provide examples of possible structures and process steps for the disclosed inventive systems and methods.

FIG. 1 illustrates in perspective view an exemplary gaming machine.

FIG. 2 illustrates in block diagram format various exemplary devices of a gaming machine according to one embodiment of the present invention.

FIG. 3 illustrates in block diagram format an exemplary network topology according to one embodiment of the present invention.

FIG. 4 illustrates in block diagram format a simplified communication topology according to one embodiment of the present invention.

FIG. 5 illustrates in block diagram format an exemplary pachinko game showing various pathways being played on a gaming machine according to one embodiment of the present invention.

FIG. 6 illustrates a flowchart of one method of displaying a physically realistic animation of a game of chance on a gaming machine according to one embodiment of the present invention.

### DETAILED DESCRIPTION

Exemplary applications of systems and methods according to the present invention are described as follows. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as definitive or limiting in scope or setting. Although these examples are described in sufficient detail to enable one skilled in the art to practice the invention, it will be understood that they are not limiting, such that other embodiments may be used and changes may be made without departing from the spirit and scope of the invention.

Various embodiments are described herein in the context of a hardware accelerated physics modeling in a gaming machine. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts. It will, of course, be appreciated that in the development of any such actual implementation, numerous implementation-specific decisions must be made in order to achieve the specific goals of the developer, such as compliance with application and business-related constraints, and that these specific goals will vary. Moreover, it will be appreciated that such a development effort might be complex and time-consuming, but would nevertheless be a routine undertaking of engineering for those of ordinary skill in the art having the benefit of this disclosure.

The present invention provides for a hardware accelerated physics modeling of animation for display on a processor based gaming machine. The use of a specialized physics processor is implemented, which results in the need for less memory space, allows for perceived player interaction of the game outcome, and provides the ability to display real-time realistic animation of the game outcome.

### Gaming Machine

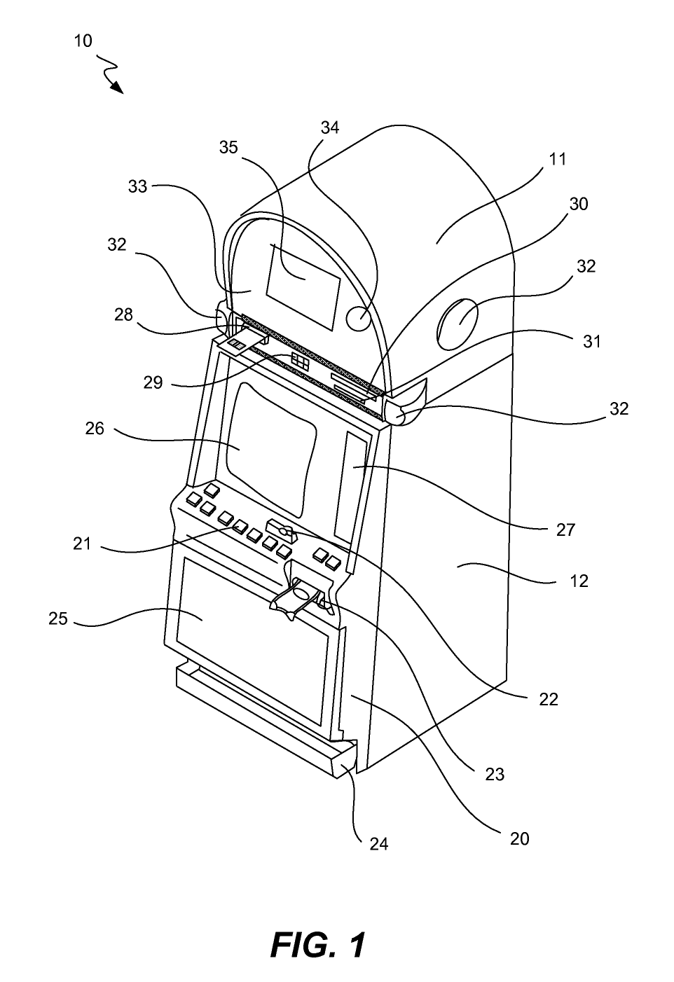

Referring first to FIG. 1, an exemplary gaming machine is illustrated in perspective view. Gaming machine 10 includes a top box 11 and a main cabinet 12, which generally surrounds the machine interior (not shown) and is viewable by users. This top box and/or main cabinet can together or separately form an exterior housing adapted to contain a plurality of internal gaming machine components therein. Main cabinet 12 includes a main door 20 on the front of the gaming machine, which preferably opens to provide access to the gaming machine interior. Attached to the main door are typically one or more player-input switches or buttons 21, one or more money or credit acceptors, such as a coin acceptor 22 and a bill or ticket validator 23, a coin tray 24, and a belly glass 25. Viewable through main door 20 is a primary video display monitor 26 and one or more information panels 27. The primary video display monitor 26 will typically be a cathode ray tube, high resolution flat-panel LCD, plasma/LED display or other conventional or other type of appropriate video monitor. Alternatively, a plurality of gaming reels can be used as a primary gaming machine display in place of display monitor 26, with such gaming reels preferably being electronically controlled, as will be readily appreciated by one skilled in the art.

Top box 11, which typically rests atop of the main cabinet 12, may contain a ticket dispenser 28, a key pad 29, one or more additional displays 30, a card reader 31, one or more speakers 32, a top glass 33, one or more cameras 34, and a secondary video display monitor 35, which can similarly be a cathode ray tube, a high resolution flat-panel LCD, a plasma/LED display or any other conventional or other type of appropriate video monitor. Alternatively, secondary display monitor 35 might also be foregone in place of other displays, such as gaming reels or physical dioramas that might include other moving components, such as, for example, one or more movable dice, a spinning wheel or a rotating display. It will be understood that many makes, models, types and varieties of gaming machines exist, that not every such gaming machine will include all or any of the foregoing items, and that many gaming machines will include other items not described above. Such gaming machines are made by a variety of manufacturers, such as, for example, IGT of Reno, Nev.

With respect to electronic gaming machines in particular, the electronic gaming machines made by IGT are provided with special features and additional circuitry that differentiate them from general-purpose computers, such as a laptop or desktop personal computer (“PC”). Because gaming machines are highly regulated to ensure fairness, and in many cases are operable to dispense monetary awards of millions of dollars, hardware and software architectures that differ significantly from those of general-purpose computers may be implemented into a typical electronic gaming machine in order to satisfy security concerns and the many strict regulatory requirements that apply to a gaming environment. A general description of many such specializations in electronic gaming machines relative to general-purpose computing machines and specific examples of the additional or different components and features found in such electronic gaming machines will now be provided.

At first glance, one might think that adapting PC technologies to the gaming industry would be a simple proposition, since both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

Accordingly, one difference between gaming machines and common PC based computers or systems is that gaming machines are designed to be state-based systems. In a state-based system, the system stores and maintains its current state in a non-volatile memory, such that in the event of a power failure or other malfunction the gaming machine will return to its current state when the power is restored. For instance, if a player were shown an award for a game of chance and the power failed before the award was provided, the gaming machine, upon the restoration of power, would return to the state where the award was indicated. As anyone who has used a PC knows, PCs are not state machines, and a majority of data is usually lost when a malfunction occurs. This basic requirement affects the software and hardware design of a gaming machine in many ways.

A second important difference between gaming machines and common PC based computer systems is that for regulation purposes, the software on the gaming machine used to generate the game of chance and operate the gaming machine must be designed as static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulator in a particular jurisdiction and installed in the presence of a person representing the gaming jurisdiction. Any change to any part of the software required to generate the game of chance, such as, for example, adding a new device driver used by the master gaming controller to operate a device during generation of the game of chance, can require a new EPROM to be burnt, approved by the gaming jurisdiction, and reinstalled on the gaming machine in the presence of a gaming regulator. Regardless of whether the EPROM solution is used, to gain approval in most gaming jurisdictions, a gaming machine must demonstrate sufficient safeguards that prevent an operator of the gaming machine from manipulating hardware and software in a manner that gives the operator an unfair or even illegal advantage over a player. The code validation requirements in the gaming industry affect both hardware and software designs on gaming machines.

A third important difference between gaming machines and common PC based computer systems is that the number and kinds of peripheral devices used on a gaming machine are not as great as on PC based computer systems. Traditionally in the gaming industry, gaming machines have been relatively simple in the sense that the number of peripheral devices and the number of functions on the gaming machine have been limited. Further, the functionality of a gaming machine tends to remain relatively constant once the gaming machine is deployed, in that new peripheral devices and new gaming software is infrequently added to an existing operational gaming machine. This differs from a PC, where users tend to buy new and different combinations of devices and software from different manufacturers, and then connect or install these new items to a PC to suit their individual needs. Therefore, the types of devices connected to a PC may vary greatly from user to user depending on their individual requirements, and may also vary significantly over time for a given PC.

Although the variety of devices available for a PC may be greater than on a gaming machine, gaming machines still have unique device requirements that differ from a PC, such as device security requirements not usually addressed by PCs. For instance, monetary devices such as coin dispensers, bill validators, ticket printers and computing devices that are used to govern the input and output of cash to a gaming machine have security requirements that are not typically addressed in PCs. Many PC techniques and methods developed to facilitate device connectivity and device compatibility do not address the emphasis placed on security in the gaming industry. To address some of these issues, a number of hardware/software components and architectures are utilized in gaming machines that are not typically found in general-purpose computing devices, such as PCs. These hardware/software components and architectures include, but are not limited to, items such as watchdog timers, voltage monitoring systems, state-based software architectures and supporting hardware, specialized communication interfaces, security monitoring, and trusted memory.

A watchdog timer is normally used in IGT gaming machines to provide a software failure detection mechanism. In a normal operating system, the operating software periodically accesses control registers in a watchdog timer subsystem to “re-trigger” the watchdog. Should the operating software not access the control registers within a preset timeframe, the watchdog timer will time out and generate a system reset. Typical watchdog timer circuits contain a loadable timeout counter register to allow the operating software to set the timeout interval within a certain time range. A differentiating feature of some preferred circuits is that the operating software cannot completely disable the function of the watchdog timer. In other words, the watchdog timer always functions from the time power is applied to the board.

IGT gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage-monitoring circuitry, these types of circuits only report voltage status to the operating software. Out of tolerance voltages can cause software malfunction, creating a potential uncontrolled condition in the gaming computer. IGT gaming machines, however, typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for IGT gaming machine game software is to use a state machine. Each function of the game (e.g., bet, play, result) is defined as a state. When a game moves from one state to another, critical data regarding the game software is stored in a custom non-volatile memory subsystem. In addition, game history information regarding previous games played, amounts wagered, and so forth also should be stored in a non-volatile memory device. This feature allows the game to recover operation to the current state of play in the event of a malfunction, loss of power, or the like. This is critical to ensure that correct wagers and credits are preserved. Typically, battery backed RAM devices are used to preserve this critical data. These memory devices are not used in typical general-purpose computers. Further, IGT gaming computers normally contain additional interfaces, including serial interfaces, to connect to specific subsystems internal and external to the gaming machine. The serial devices may have electrical interface requirements that differ from the “standard” EIA RS232 serial interfaces provided by general-purpose computers. These interfaces may include EIA RS485, EIA RS422, Fiber Optic Serial, optically coupled serial interfaces, current loop style serial interfaces, and the like. In addition, to conserve serial interfaces internally in the gaming machine, serial devices may be connected in a shared, daisy-chain fashion where multiple peripheral devices are connected to a single serial channel.

IGT gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this. In addition, security-monitoring circuits detect intrusion into an IGT gaming machine by monitoring security switches attached to access doors in the gaming machine cabinet. Preferably, access violations result in suspension of game play and can trigger additional security operations to preserve the current state of game play. These circuits also function when power is off by use of a battery backup. In power-off operation, these circuits continue to monitor the access doors of the gaming machine. When power is restored, the gaming machine can determine whether any security violations occurred while power was off, such as by software for reading status registers. This can trigger event log entries and further data authentication operations by the gaming machine software.

Trusted memory devices are preferably included in an IGT gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the gaming machine. The code and data stored in these devices may include, for example, authentication algorithms, random number generators, authentication keys, operating system kernels, and so forth. The purpose of these trusted memory devices is to provide gaming regulatory authorities a root trusted authority within the computing environment of the gaming machine that can be tracked and verified as original. This may be accomplished via removal of the trusted memory device from the gaming machine computer and verification of the secure memory device contents is a separate third party verification device. Once the trusted memory device is verified as authentic, and based on the approval of verification algorithms contained in the trusted device, the gaming machine is allowed to verify the authenticity of additional code and data that may be located in the gaming computer assembly, such as code and data stored on hard disk drives.

Mass storage devices used in a general-purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present. In addition to the basic gaming abilities provided, these and other features and functions serve to differentiate gaming machines into a special class of computing devices separate and distinct from general-purpose computers.

With respect to the basic gaming abilities provided, it will be readily understood that gaming machine 10 can be adapted for presenting and playing any of a number of gaming events, particularly games of chance involving a player wager and potential monetary payout, such as, for example, a wager on a sporting event or on general localized play as slot machine games, video pachinko games, lottery games, video ring toss games, video billiards games, video coin-in-plate games, video ball-in-jug games, video wheel of fortune games, video roulette games, video craps games, video keno games, video poker games, video blackjack games, and/or any other video table game, among others. Other features and functions may also be used in association with gaming machine 10, and it is specifically contemplated that the present invention can be used in conjunction with such a gaming machine or device that might encompass any or all such additional types of features and functions. One item that is specifically contemplated for use with the present invention involves a gaming machine adapted to operate in conjunction with a specialized physics processor for the presentation of improved multi-object animated displays, as set forth in greater detail below.

When a user wishes to play a game on the gaming machine 10, he or she can insert cash or credit through the coin acceptor, bill validator or other credit-in device. Additionally, the bill validator may accept a printed ticket voucher, which may be accepted by the bill validator as indicia of credit when a cashless ticketing system is used. At the start of the game, the player may enter playing tracking information using the card reader, the keypad, and/or the display. Further, other game preferences of the player playing the game may be read from a card inserted into the card reader. During the game, the player can view game information using the video display. Other game and prize information may also be displayed in the video display screen located in the top box.

During the course of a game, a player may be required to make a number of decisions, which affect the outcome of the game. For example, a player may vary his or her wager on a particular game, select a prize for a particular game selected from a prize server, or make game decisions that affect the outcome of a particular game. The player may make these choices using the player-input switches, the video display screen and/or some other device which enables a player to input information into the gaming machine. In some embodiments, the player may be able to access various game services such as concierge services and entertainment content services using the video display screen and one more input devices.

In other examples, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device, such as, but not limited to, a cell phone, a personal digital assistant, and a wireless game player. Images rendered from 3-D gaming environments may be displayed on portable gaming devices that are used to play a game of chance. Further, a gaming machine or server may include gaming logic for commanding a remote gaming device to render an image from a virtual camera in a 3-D gaming environments stored on the remote gaming device and to display the rendered image on a display located on the remote gaming device. Those of skill in the art will understand that the present invention, as described below, can be deployed on most any gaming machine now available or hereafter developed.

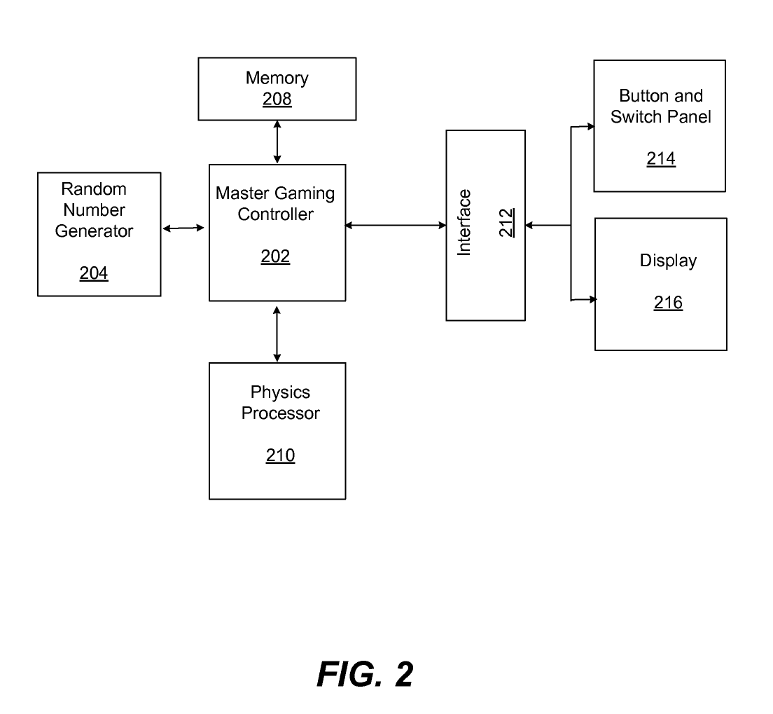

Moving next to FIG. 2, a block diagram illustrating various exemplary devices of a gaming machine is provided. Such a gaming machine can be identical or similar to gaming machine 10 of FIG. 1. A master gaming controller 202 controls the games played on the gaming machine. The master gaming controller may be in communication with other devices via any known system bus 206 such as a PCI, PCI-X, PCI-Express, or Ethernet type bus. The master gaming controller 202 may also be coupled to or in communication with a random number generator 204 to predetermine an outcome for a game of chance. In fact, a predetermined game outcome can be rendered before any graphical display or presentation is provided regarding the game play. Once a game outcome is determined, the presentation on the display can then be provided in accordance with the predetermined game outcome.

To display the game of chance in a physically realistic animated manner, a physics processor 210 may be coupled to the master gaming controller 202. The physics processor 210 may be designed or configured to generate physics data based upon the predetermined game outcome generated by the master gaming controller 202. It will be understood that physics processor 210 is used primarily to provide a realistic graphical display, and that the physics processor should take no part in the determination of any actual game outcome. The physics data generated by the physics processor may be used to display a physically realistic animation of game play for the game of chance. Such a physics processor 210 can be selected from any of a number of suitable physics processors. One such exemplary physics processor is the PhysX™ processor made by Ageia of Mountain View, Calif., although other physics processor may also be used.

The gaming software to play the game of chance, including predetermined pay tables, may be stored on a memory 208 of the gaming-machine that is also in communication with the master gaming controller 202. The predetermined pay tables may be chosen based upon the amount of wager played for the game of chance. In current gaming machines, numerous sets of predetermined display conditions with predetermined outcomes for each game of chance played may also be stored in the memory 208. However, with the use of a dedicated physics processor 210 that is able to calculate physics data in real-time, memory space to store the sets of predetermined display conditions are no longer required. The additional memory may be used to store other resources such as gaming software to play additional games of chance on the gaming machine. Alternatively, the memory 208 may be shared with other devices such as the physics processor 210. Thus, with the use of a physics processor 210, games may be displayed and animated using non-predetermined display conditions in real-time.

The master gaming controller 202 may also be in communication with various peripheral devices, such as player input mechanisms, through interface 212. The player input mechanisms may be used to detect real-time input signals from a player to play the game of chance. The player input mechanism can include, for example, a button or switch panel 214 having buttons and switches to obtain input from the player. Alternatively, or in addition, player input mechanisms may include display 216, wherein the display 216 is a touch screen display adapted to receive player input. As a particular example, and as further discussed below, the game of chance may allow the player to position the ball and/or pins in a virtual pachinko game prior to or after start of game play. Alternatively, the player may position a coin for a virtual coin-in-dish game of chance. In another example, the user may roll the dice for a virtual craps game. Numerous alternatives similarly allow a player to provide more specific input on how a simulated physical game is played, thus giving the player the perception that he or she is in some way in control of a game outcome.

As noted above, however, many or all games can have outcomes that are determined prior to and/or independent of any player input. Such predetermined outcomes may be necessary, for example, where gaming regulators do not permit any skill or particular input of a player to affect the game outcome by the gaming machine. In such instances, many or all game outcomes are determined by the master gaming controller regardless of any player positioning or input regarding virtual physical items, such as pachinko balls or pins. The MGC provides a predetermined game outcome to the physics processor 210, which uses this predetermined outcome in its processing of the actual game play that will be displayed for the player.

The real-time player input may also be sent to the physics processor 210 to aid in the generation of physics data, in order to display a realistic animation of the actual play for the game of chance. Thus, the physics data may be based upon both the game outcome generated by the master gaming controller 202 and the real-time player input as discussed below. Furthermore, the pay tables may be dynamic and change based upon the input from the player. The pay table may be chosen based upon the game outcome as well as the real-time player input received by the master gaming controller 202, as further discussed below.

Although the specialized physics processing can be done by a separate dedicated processor, such as physics processor 210 described above, it will be readily appreciated that the various physics calculations and modeling can also be done by one or more components on a system video card or by one or more cores of a multi-core system. For example, physics processor 210 might be a dedicated processor located on an existing video card, and/or might be a portion of a processor on a video card or other system component. Alternatively, one or more of the cores in a multi-core can be dedicated to doing the specialized physics processing, while the other core or cores perform all other core functions. One of skill in the art will appreciate that the specific designation or location of the specialized physics processing can be in any of a number of locations and/or processors without detracting from the overall spirit and scope of the invention.

### Gaming Network

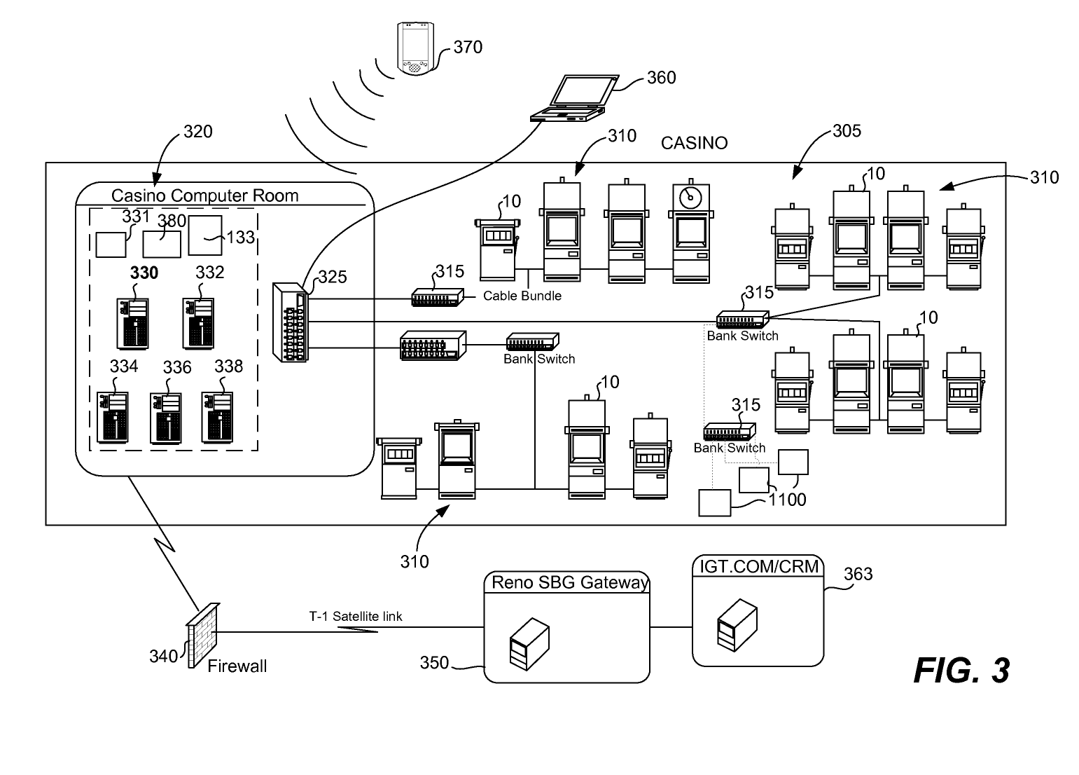

As described above, the physics processor 210 may be located within the gaming machine 10. Alternatively, the physics processor may be located on a remote gaming server. One example of a network topology for implementing this aspect, as well as others, is shown in FIG. 3. Those of skill in the art will realize that this exemplary architecture and the related functionality are merely examples and that the present invention encompasses many other such embodiments and methods. For example, other alternative embodiments can involve the use of “thin” player terminals, whereby the master gaming controller and/or other processors are located remotely from the gaming machine. Such “thin” player terminals might include little more than player input devices and output devices such as displays, where much or all of the processing is done remotely from the player terminal.

In this particular example, a single gaming establishment 305 is illustrated, which is a casino here. However, it should be understood that some implementations of the present invention involve multiple gaming establishments. Gaming establishment 305 includes, for example, sixteen gaming machines 10, each of which is part of a bank 310 of gaming machines. In this example, gaming establishment 305 also includes a bank of networked gaming tables 1100. It will be appreciated that many gaming establishments include hundreds or even thousands of gaming machines 10 and/or gaming tables 1100, not all of which are included in a bank. However, the present invention may be implemented in gaming establishments having any number of gaming machines, gaming tables and/or other gaming devices and venues, as will be readily appreciated.

Various alternative network topologies can be used to implement different aspects of the invention and/or to accommodate varying numbers of networked devices. For example, gaming establishments with very large numbers of gaming machines 10 may require multiple instances of some network devices (e.g., of main network device 325, which combines switching and routing functionality in this example) and/or the inclusion of other network devices not shown in FIG. 3. For example, some implementations of the invention include one or more middleware servers disposed between gaming machines 10 and server 330. Such middleware servers can provide various useful functions, including but not limited to the filtering and/or aggregation of data received from bank switches 315, from individual gaming machines and from other player terminals. Some implementations of the invention include load balancing methods and devices for managing network traffic.

Each bank 310 can have a corresponding bank switch 315, which may be a conventional bank switch. Each bank switch is connected to server-based gaming (SBG) server 330 via main network device 325, which combines switching and routing functionality in this example. Although various alternative floor communication protocols may be used, some preferred implementations use the open, Ethernet-based SuperSAS® protocol by IGT.

SBG server 330, License Manager 331, Arbiter 133, physics processor 380, servers 332, 334, 336 and 338, and main network device 325 can be disposed within computer room 320 of gaming establishment 305. In practice, more or fewer servers may be used. Some of these servers may be configured to perform tasks relating to player tracking, bonusing/progressives, and so forth. Some servers may be configured to perform tasks specific to the present invention such as calculating physics data to display a realistic animation of the game played. License Manager 331 may also be implemented, at least in part, via a server or a similar device. Some exemplary operations of License Manager 331 are described in detail in U.S. patent application Ser. No. 11/225,408, entitled “Methods and Devices for Authentication and Licensing in a Gaming Network” by Kinsley, et al., which is hereby incorporated by reference for this purpose.

SBG server 330 can also be configured to implement, at least in part, various aspects of the present invention. Some preferred embodiments of SBG server 330 and the other servers shown in FIG. 3 include, or are at least in communication with, clustered CPUs, redundant storage devices—including backup storage devices—switches, and the like. Such storage devices may include a redundant array of inexpensive disks, back-up hard drives and/or tape drives, and the like. Preferably, a Radius and a DHCP server are also configured for communication with the gaming network. Some implementations of the invention can provide one or more of these servers in the form of blade servers.

In some implementations of the present invention, many of these devices (including but not limited to License Manager 331, servers 332, 334, 336 and 338, and main network device 325) can be mounted in a single rack with SBG server 330. Accordingly, many or all such devices will sometimes be referenced in the aggregate as an “SBG server.” However, in alternative implementations, one or more of these devices is in communication with SBG server 330 and/or other devices of the network but located elsewhere. For example, some of the devices could be mounted in separate racks within computer room 320 or located elsewhere on the network. For example, it can be advantageous to store large volumes of data elsewhere via a storage area network. In some embodiments, these components are SBG server 330 preferably has an uninterruptible power supply (UPS). The UPS may be, for example, a rack-mounted UPS module.

Computer room 320 may include one or more operator consoles or other host devices that are configured for communication with SBG server 330. Such host devices may be provided with software, hardware and/or firmware for implementing various aspects of the invention; many of these aspects involve controlling SBG server 330. However, such host devices need not be located within computer room 320. Wired host device 360 (which is a laptop computer in this example) and wireless host device (which is a PDA in this example) may be located elsewhere in gaming establishment 305 or at a remote location.

Arbiter 133 may be implemented via software that is running on a server or another networked device, and can serve as an intermediary between different devices on the network. Some implementations of Arbiter 133 are described in U.S. patent application Ser. No. 10/948,387, entitled “Methods and Apparatus for Negotiating Communications within a Gaming Network,” which is incorporated herein by reference and for all purposes. In some preferred implementations, Arbiter 133 is a repository for the configuration information required for communication between devices on the gaming network (and, in some implementations, devices outside the gaming network). Although Arbiter 133 can be implemented in various ways, one exemplary implementation follows.

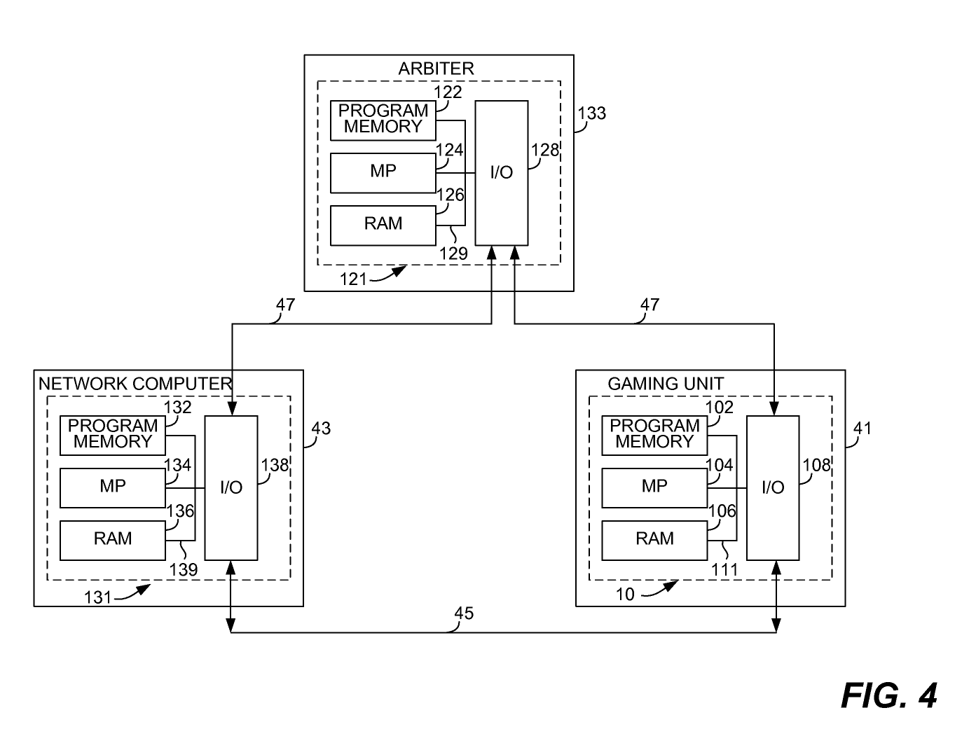

FIG. 4 is a block diagram of a simplified communication topology between a gaming unit 41, the network computer 43 and the Arbiter 133. Although only one gaming unit 41, one network computer 43 and one Arbiter 133 are shown in FIG. 4, it will be understood that the following examples may be applicable to different types of network gaming devices within the gaming network beyond the gaming unit 41 and the network computer 43, and may include different numbers of network computers, gaming security arbiters and gaming units. For example, a single Arbiter 133 may be used for secure communications among a plurality of network computers 43 and tens, hundreds or thousands of gaming units 41. Likewise, multiple gaming security arbiters may be utilized for improved performance and other scalability factors.

Arbiter 133 may include an arbiter controller 121 that may comprise a program memory 122, a microcontroller or microprocessor (MP) 124, a random-access memory (RAM) 126 and an input/output (I/O) circuit 128, all of which may be interconnected via an address/data bus 129. The network computer 43 may also include a controller 131 that may comprise a program memory 132, a microcontroller or microprocessor (MP) 134, a random-access memory (RAM) 136 and an input/output (I/O) circuit 138, all of which may be interconnected via an address/data bus 139. It should be appreciated that although the Arbiter 133 and the network computer 43 are each shown with only one microprocessor 124, 134, the controllers 121, 131 may each include multiple microprocessors 124, 134. Similarly, the memory of the controllers 121, 131 may include multiple RAMs 126, 136 and multiple program memories 122, 132. Although the I/O circuits 128, 138 are each shown as a single block, it should be appreciated that the I/O circuits 128, 138 may include a number of different types of I/O circuits. The RAMs 124, 134 and program memories 122, 132 may be implemented as semiconductor memories, magnetically readable memories, and/or optically readable memories, for example.

Although the program memories 122, 132 are shown in FIG. 4 as read-only memories (ROM) 122, 132, the program memories of the controllers 121, 131 may be a read/write or alterable memory, such as a hard disk. In the event a hard disk is used as a program memory, the address/data buses 129, 139 shown schematically in FIG. 4 may each comprise multiple address/data buses, which may be of different types, and there may be an I/O circuit disposed between the address/data buses.

As shown in FIG. 4, the gaming unit 41 may be operatively coupled to the network computer 43 via the data link 45. The gaming unit 41 may also be operatively coupled to the Arbiter 133 via the data link 47, and the network computer 43 may likewise be operatively coupled to the Arbiter 133 via the data link 47. Communications between the gaming unit 41 and the network computer 43 may involve different information types of varying levels of sensitivity resulting in varying levels of encryption techniques depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings and the like), game download information (e.g., game software and game licensing information) and personal information (e.g., social security number, personal preferences, and the like) may be encrypted with stronger encryption techniques such as DES or 3DES to provide increased security.

Arbiter 133 may verify the authenticity of each network gaming device. The Arbiter 133 may receive a request for a communication session from a network device. For ease of explanation, the requesting network device may be referred to as the client, and the requested network device may be referred to as the host. The client may be any device on the network and the request may be for a communication session with any other network device. The client may specify the host, or the gaming security arbiter may select the host based on the request and based on information about the client and potential hosts. The Arbiter 133 may provide encryption keys (session keys) for the communication session to the client via the secure communication channel. Either the host and/or the session key may be provided in response to the request, or may have been previously provided. The client may contact the host to initiate the communication session. The host may then contact the Arbiter 133 to determine the authenticity of the client. The Arbiter 133 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, the Arbiter 133 may contact the host regarding the request and provide corresponding session keys to both the client and the host. The Arbiter 133 may then initiate either the client or the host to begin their communication session. In turn, the client and host may begin the communication session directly with each other using the session keys to encrypt and decrypt messages.

Wireless devices are particularly useful for managing a gaming network. Such wireless devices could include, but are not limited to, laptops, PDAs or even cellular telephones. Referring once again to FIG. 3, one or more network devices in gaming establishment 305 can be configured as wireless access points. For example, a casino manager may use a wireless handheld device to revise and/or schedule gaming machine configurations while roaming the casino floor. Similarly, a representative of a regulatory body could use a PDA to verify gaming machine configurations, generate reports, view activity logs, and perform other similar functions while on the casino floor.

### Pachinko Example

In an exemplary embodiment, and not intended to be limiting, as the invention may be used to play other virtual games of chance, the invention will be described with reference to a gaming machine adapted to play virtual pachinko. A more detailed explanation of embodiments to play pachinko is described in U.S. Pat. No. 7,125,333 entitled “Video Pachinko on a Video Platform as a Gaming Device,” which is incorporated herein by reference. Briefly, pachinko is similar to the modern pinball machine. Metal balls are typically shot on the playing surface of the machine, where they go around and through a series of nails, pins and/or other items. The objective is to direct the balls into pockets. Once the ball lands into these winning pockets, the player will receive more balls equivalent to a certain prize or a cash pay out. The movement and direction of these steel balls rely primarily on luck and the winning prize is therefore dictated by chance.

Currently, instructions to animate the play a virtual pachinko game involve sets of predetermined display conditions saved on a memory. These sets of predetermined display conditions may be modeled or based upon the predetermined outcomes for each game played. However, when multiple pachinko balls are played simultaneously, it is a challenge to model the display conditions, since the number of possible pathways, collisions, iterations, and combinations increase in a manner that can not be contained within one data structure. As such, the ability to simulate the play of multiple pachinko balls in a virtual environment has been limited to date.

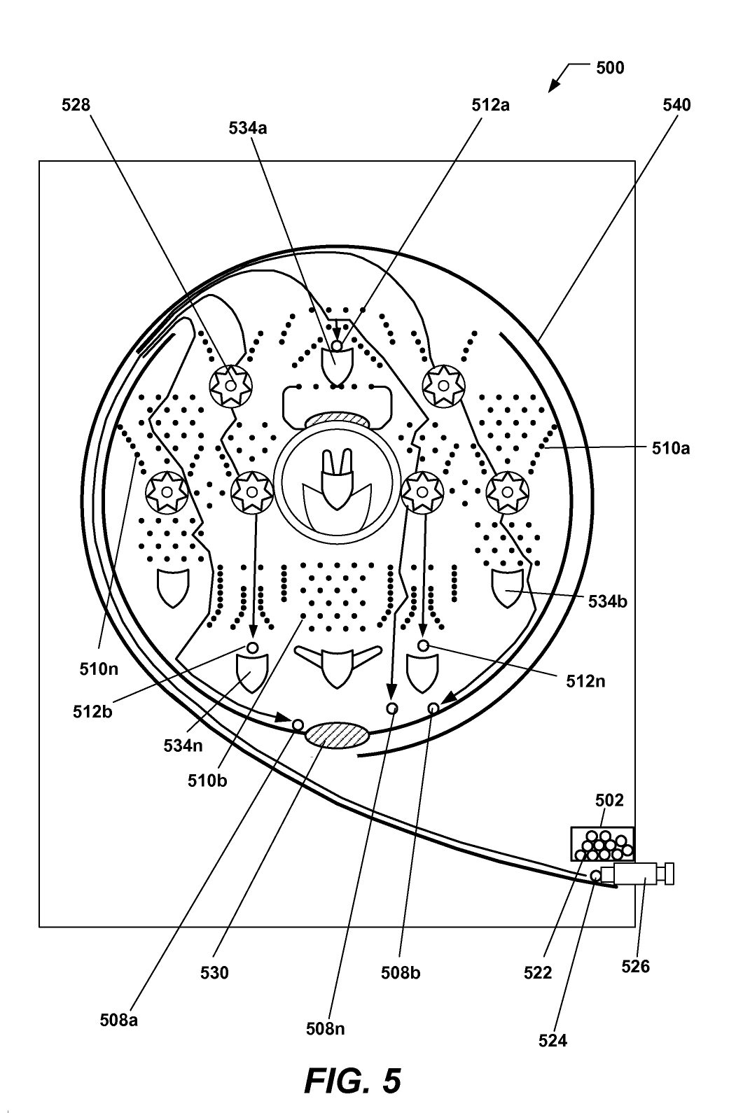

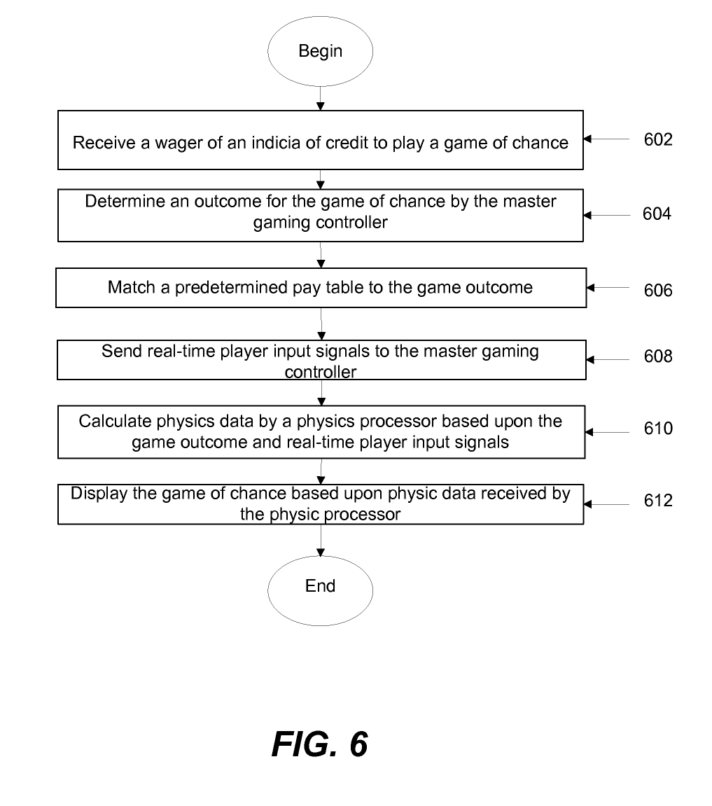

Calculating the various display conditions for such a virtual multi-ball pachinko game can be enhanced with the use of a physics processor, however, since such a processor can calculate the physics data of multiple animated objects in real-time. Referring now to FIG. 5, a block diagram of an exemplary pachinko game showing various pathways being played on a gaming machine is illustrated. Further, FIG. 6 provides a flow diagram of an exemplary method for displaying a physically realistic animation of a game of chance, such as a pachinko game. The virtual pachinko gaming machine 500 operates when the gaming machine receives a wager of an indicia of credit at process step 602 on an outcome of the game of chance, wherein the gaming machine includes a wager input mechanism for allowing the indicia of credit to be added to the gaming machine and a wager output mechanism for allowing a player to receive the indicia of credit. The wager input and/or output mechanism may be a bill validator or a ticket printer for cashless gaming, as noted above. A game outcome for the game of chance may be determined by the master gaming controller at process step 604 and a predetermined pay table may be matched to the game outcome at process step 606.

Virtual steel balls 522 may then appear to be dropped into a loading area 502. The player may then use the player input mechanisms to send real-time player input signals to release a ball. The real-time player input signals may be sent to the master gaming controller at process step 608. The player input mechanism may be obtained, for example, from a touch screen display whereby the player may drag the ball 534 down. The player may also virtually pull a knob 526 in order the release the ball 524 in an attempt to control the speed of the balls 522. The force of the knob 542 may be determined by the length the player pulls the virtual knob out and/or how quickly the player releases the knob. This may be achieved virtually on a touch screen display by any means such as using a finger to drag and release the knob displayed on the screen. Alternatively, the player may depress a button on the button or switch panel and the amount of time the button is depressed may determine how hard or soft the player pulls the knob. Other types of player inputs may also be used.

In some embodiments, the player may virtually reposition the pins 510a, b, n (where n is a positive integer). By using a touch screen display, a player may be able to reposition the pins 510a, b, n in any known manner such as by dragging one or more pins 510a, b, n to the position the player would like the pins 510a, b, n to be placed. In some embodiments, the player may be given the option of placing the ball at a pre-approved location within the game 540 (as opposed to using the knob 526) to release the ball and start the game. Player inputs received to relocate the pins and/or balls may cause the pay table to change. The player inputs may be received by the physics processor, which may then determine a new pay table for the game play. The pay table may then be dynamically displayed to the player on the display in real-time.

By allowing the player the option to relocate the pins and balls, it gives the appearance that the player has some control in determining the outcome of the game. As noted above, however, many gaming regulators may not allow for such player inputs to actually determine a game outcome. Accordingly, it is preferable for a game outcome to be determined by a random number generator only, and regardless of any such particularized player inputs. The function of the specialized physics processor is then to use the predetermined game outcome and particularized player inputs to present a realistic looking game play that arrives at the predetermined game outcome.

From the perspective of player, if a player is not lucky, the balls will fall through the pins to the ball exit 530 without entering a pocket 534a, b, n as illustrated with the pathways for balls 508a, b, n. In such cases, no “win” condition would be declared for the player of such a game. However, a “successful” launch of the metal balls 524 may result in one or more balls entering one or more pockets 534a, b, n, as illustrated with pathways for balls 512a, b, n. In such cases, a “win” condition and corresponding win amount or prize would then be awarded to the player.

To display the animation in a physically realistic animation showing the deflection and/or trajectory of the balls, physics data may be calculated by a physics processor at process step 610 based upon the predetermined game outcome for the game of chance and/or the player input signal. The physics processor may apply a random mass, spin, and/or velocity to calculate a trajectory or path for each of the balls. As such, the physics processor may also be viewed as an additional random number generator by randomly varying the physical characteristics of each of the balls, which increases the randomness of the game play. Regardless of any random number generation done by the physics processor, the physics processor preferably has no input regarding the actual outcome of a game. Again, the specialized physics processor preferably operates with the predetermined game outcome generated by the master gaming controller as a non-variable parameter in its processing functions. Once calculated, the physics data may be sent to the master gaming controller and/or other display processor or device to display a physically realistic animation of the pachinko game on the display at process step 612. The plays of the balls may include collisions with other balls, pins, walls, or obstructions 528 in the game.

Although described with reference to a virtual pachinko game, the invention may be used to play any virtual game of chance such as ring toss, billiards, coin-in-plate, ball-in-jug, wheel of fortune, pachinko, roulette, craps and card games. For example, the player may be given the opportunity to spin a virtual wheel of a wheel of fortune game or roll the dice for a virtual craps game. This gives the player the appearance and/or feeling of control on how fast or slow the wheel rotates or the dice are rolled, although the game outcome may already be predetermined.

In various alternative embodiments, the specialized inputs by a player may affect the outcome of the game. As noted above, it may be preferable to vary any applicable pay table to correspond to such player adjustments. For example, where a player might elect to move numerous pachinko pins such that a virtual “funnel” is created to a particular pachinko pocket, corresponding calculations within the gaming machine might then favor that pocket as a potential game outcome. The pay table for the game could then be adjusted accordingly, such that the payout for a ball landing in such a favored pocket is then reduced. Similar considerations can apply for other player controlled factors with respect to other games.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. A gaming machine, comprising:
at least one wager input mechanism adapted to receive a wager by a player to play a game of chance and to send a wager input signal indicating the amount of the wager received;
a player input mechanism adapted to detect a player input signal from the player to play said game of chance;
a master gaming controller configured to receive said wager input signal, to receive said player input signal, to generate a predetermined game outcome for said game of chance, and to facilitate the presentation of said game of chance;
a physics processor coupled to the master gaming controller and configured to generate physics data, wherein said physics data is generated based upon said predetermined game outcome and said player input signal received from said master gaming controller; and
a display coupled to said master gaming controller and adapted to present a realistic animation of the play of said game of chance, wherein said realistic animation is based at least in part on said generated physics data.

2. The gaming machine of claim 1, wherein said physics processor communicates with the master gaming controller through a system bus.

3. The gaming machine of claim 1, wherein said system bus is selected from the group consisting of: PCI, PCI-X, PCI-Express and Ethernet.

4. The gaming machine of claim 1, wherein said predetermined game outcome is mapped to a predetermined paytable.

5. The gaming machine of claim 4, wherein said predetermined paytable is a dynamic paytable based at least in part upon said player input signal.

6. The gaming machine of claim 1, wherein the display of the play of said game of chance is not a stored pre-scripted animation.

7. The gaming machine of claim 1, wherein said player input mechanism is a touch screen display.

8. The gaming machine of claim 1, wherein said player input mechanism is a button or switch panel.

9. The gaming machine of claim 1, wherein said game of chance comprises one or more games of chance selected from the group consisting of ring toss, billiards, coin-in-plate, ball-in-jug, wheel of fortune, pachinko, roulette, craps and card games.

10. A gaming system, comprising:
a player terminal including
at least one wager input mechanism adapted to receive a wager by a player to play a game of chance and to send a wager input signal indicating the amount of the wager received,
at least one player input mechanism adapted to detect a player input signal from the player to play said game of chance, and
a display adapted to present a realistic animation of the play of said game of chance, wherein said realistic animation is based at least in part on generated physics data;
a master gaming controller configured to receive said wager input signal, to receive said player input signal, to generate a predetermined game outcome for said game of chance, and to facilitate the presentation of said game of chance; and
a physics processor coupled to the master gaming controller and configured to generate said physics data, wherein said physics data is generated based upon said predetermined game outcome and said player input signal received from said master gaming controller,
wherein at least one of said master gaming controller and said physics processor are located remotely from said player terminal.

11. A method for playing a game of chance on a gaming machine, comprising:
receiving a player wager on a game of chance at a gaming machine having a player wager input mechanism;
receiving at said gaming machine a player input signal regarding a parameter of the play of said game of chance;
determining a predetermined game outcome for said game of chance under control of a master gaming controller of said gaming machine;
calculating physics data based upon said predetermined game outcome for said game of chance and said player input signal, said physics data being calculated by a physics processor associated with said master gaming controller; and
displaying a realistic animation of the play of said game of chance on a display of said gaming machine, wherein said realistic animation is based upon said physics data.

12. The method of claim 11, further including the step of:
communicating said physics data from the physics processor to the master gaming controller.

13. The method of claim 11, wherein said game of chance is selected from the group consisting of: ring toss, billiards, coin-in-plate, ball-in-jug, wheel of fortune, pachinko, roulette, craps and card games.

14. The method of claim 11, wherein said determining step further comprises matching said predetermined game outcome to a predetermined paytable.

15. The method of claim 14, further including the step of:
dynamically changing said paytable based upon said player input signal.

16. The method of claim 11, wherein said step of receiving the player input signal occurs during the play of said game.

17. The method of claim 11, wherein said physics processor resides on a remote gaming server.
